(19) United States
(12) Patent Application Publication
(10) Pub. No.: US 2026/0169405 A1
(43) Pub. Date: Jun. 18, 2026

(54) IMAGE FORMING SYSTEM

(71) Applicant: FUJIFILM Business Innovation Corp., Tokyo (JP)

(72) Inventors: Naoki NOGAMI, Kanagawa (JP); Tomoaki YOSHIOKA, Kanagawa (JP); Yuki YOKOYAMA, Kanagawa (JP); Kota NAKAJIMA, Kanagawa (JP)

(73) Assignee: FUJIFILM Business Innovation Corp., Tokyo (JP)

(21) Appl. No.: 19/209,825

(22) Filed: May 16, 2025

(30) Foreign Application Priority Data
Dec. 16, 2024 (JP) 2024-219674

(51) Int. Cl. G03G 15/16; G03G 15/00

(52) U.S. Cl. CPC G03G 15/167; G03G 15/1605; G03G 15/6564

(57) ABSTRACT

An image forming system includes an endless intermediate transfer body that is wound around plural rolls and moves in a circulation direction, and transports a toner image that is primarily transferred onto an outer peripheral surface; a transfer rotating body that rotates and comes into contact with the intermediate transfer body, and transfers the toner image of the intermediate transfer body onto a medium at a secondary transfer position facing the intermediate transfer body; a counter rotating body that rotates and faces the transfer rotating body while interposing the intermediate transfer body, and forms a potential difference between the transfer rotating body and the counter rotating body; a guide portion that is provided on an upstream side of the secondary transfer position in a transport direction of the medium, and guides the medium to the secondary transfer position; and a movement portion that moves an entire medium contact portion in the guide portion in a direction approaching or separating from the intermediate transfer body while maintaining a posture in a direction intersecting a line connecting a center of the transfer rotating body and a center of the counter rotating body, according to a type of the medium.

### CROSS-REFERENCE TO RELATED APPLICATIONS

This application is based on and claims priority under 35 USC 119 from Japanese Patent Application No. 2024-219674 filed Dec. 16, 2024.

### BACKGROUND

### (i) Technical Field

The present invention relates to an image forming system.

### (ii) Related Art

JP2014-134614A discloses an image forming apparatus including an intermediate transfer belt, a secondary transfer member, an endless secondary transfer belt, a counter member, and a contact width change unit. The intermediate transfer belt is stretched around a plurality of rollers and transports a toner image on an outer peripheral surface. The secondary transfer member performs secondary transfer of the toner image on the intermediate transfer belt to a recording medium at a secondary transfer position facing the intermediate transfer belt. The secondary transfer belt is wound around the secondary transfer member and circulates while being interposed between the secondary transfer member and the intermediate transfer belt as the secondary transfer member rotates. The counter member is disposed to face the secondary transfer member to abut against an inner peripheral surface of the intermediate transfer belt and to sandwich the secondary transfer belt at the secondary transfer position. The contact width change unit changes a contact width of a contact region formed by a surface contact of a part of a peripheral surface of the intermediate transfer belt and a part of a peripheral surface of the secondary transfer belt in the secondary transfer position based on paper attribute information of the recording medium. Specifically, the contact width change unit changes the contact width of the contact region between a predetermined first contact width and a second contact width in which an increase amount of the contact width on the upstream side in the paper transport direction is large.

JP1999-143254A discloses an image forming apparatus including an image holding body, a transfer unit, a recording material transport unit, and a recording material guide unit. The image holding body holds a visible image formed of a charged coloring material. The transfer unit transfers the visible image on the image holding body to a recording material. The recording material transport unit transports the recording material to a transfer portion between the transfer unit and the image holding body. The recording material guide unit is provided in a transport path between the recording material transport unit and the transfer portion, and a posture of the recording material entering the transfer portion is restricted. The recording material guide unit includes a movable guide portion that is disposed on the image holding body side and of which at least a downstream side portion in a transport direction of the recording material is movable in the image holding direction.

JP2014-191100A discloses an image forming apparatus including one or more image holding bodies, a thin intermediate transfer body, a primary transfer member, a secondary transfer member, a surface exposure member, and a tension adjusting member. One or more image holding bodies form and hold each color component image by each color component toner. The intermediate transfer body faces the image holding body and is stretched around a plurality of tension members to be circulated and transported, and temporarily holds each color component image formed on the image holding body before transferring the color component image to the recording material. The primary transfer member is provided on a back surface of the intermediate transfer body facing the image holding body, and transfers each color component image held by the image holding body to the intermediate transfer body by forming a transfer electric field in a primary transfer region between the primary transfer member and the image holding body. The secondary transfer member is disposed to come into contact with a front surface of the intermediate transfer body by facing the tension members provided on the back surface of the intermediate transfer body, and transfers each color component image transferred to the intermediate transfer body by the primary transfer member by forming a transfer electric field in a secondary transfer region between the secondary transfer member and the image holding body. The surface exposure member is disposed to come into contact with the back surface of the intermediate transfer body on an upstream side of the intermediate transfer body in a transport direction from the secondary transfer member, and is provided to be movable forward and backward along a direction intersecting a surface direction of the intermediate transfer body to form a transport trajectory plane of the intermediate transfer body that reaches the secondary transfer region. The tension adjusting member adjusts the tension of the intermediate transfer body to offset looseness of the intermediate transfer body caused by the movement of the surface exposure member from a predetermined position.

### SUMMARY

Aspects of non-limiting embodiments of the present disclosure relate to an image forming system in which the occurrence of image quality defect is suppressed as compared with a case where only one end portion side of a medium in a transport direction of a guide portion is moved in a direction approaching or separating from the intermediate transfer body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including an endless intermediate transfer body that is wound around a plurality of rolls and moves in a circulation direction, and transports a toner image that is primarily transferred onto an outer peripheral surface; a transfer rotating body that rotates and comes into contact with the intermediate transfer body, and transfers the toner image of the intermediate transfer body onto a medium at a secondary transfer position facing the intermediate transfer body; a counter rotating body that rotates and faces the transfer rotating body while interposing the intermediate transfer body, and forms a potential difference between the transfer rotating body and the counter rotating body; a guide portion that is provided on an upstream side of the secondary transfer position in a transport direction of the medium, and guides the medium to the secondary transfer position; and a movement portion that moves an entire medium contact portion in the guide portion in a direction approaching or separating from the intermediate transfer body while maintaining a posture in a direction intersecting a line connecting a center of the transfer rotating body and a center of the counter rotating body, according to a type of the medium.

### BRIEF DESCRIPTION OF THE DRAWINGS

Exemplary embodiment(s) of the present invention will be described in detail based on the following figures, wherein:

FIG. 1 is a schematic view showing a configuration of an image forming system according to a first exemplary embodiment as seen from a front side;

FIG. 2 is a configuration diagram showing a movement direction of a guide portion in a secondary transfer unit of the image forming system according to the first exemplary embodiment;

FIG. 3 is a configuration diagram showing a state in which the guide portion in the secondary transfer unit of the image forming system according to the first exemplary embodiment is moved to a second position close to an intermediate transfer belt;

FIG. 4 is a configuration diagram showing a movement direction of a guide portion in a secondary transfer unit of an image forming system according to a second exemplary embodiment;

FIG. 5 is a configuration diagram describing a positional relationship between the guide portion and a registration roll in the secondary transfer unit of the image forming system according to the second exemplary embodiment;

FIG. 6 is a configuration diagram showing a movement direction of a guide portion in a secondary transfer unit of an image forming system according to a third exemplary embodiment;

FIG. 7 is a configuration diagram showing a state in which the guide portion in a secondary transfer unit of the image forming system according to the third exemplary embodiment is moved to a second position close to an intermediate transfer belt;

FIG. 8 is a graph showing a relationship between a height of a guide portion into which paper is entered and status of white spots caused by a pre-discharge in the image forming system according to the third exemplary embodiment;

FIG. 9 is a configuration diagram showing a movement direction of a guide portion in a secondary transfer unit of an image forming system according to a fourth exemplary embodiment; and

FIG. 10 is a configuration diagram showing a state in which the guide portion in the secondary transfer unit of the image forming system according to the fourth exemplary embodiment is moved to a second position close to an intermediate transfer belt.

### DETAILED DESCRIPTION

Hereinafter, exemplary embodiments of the present invention will be described. In the following description, a direction indicated by an arrow H in the drawings is referred to as a vertical direction, and a direction indicated by an arrow W is referred to as a horizontal direction, which is a device width direction.

### First Exemplary Embodiment

Hereinafter, an image forming system according to a first exemplary embodiment will be described.

### Overall Configuration of Image Forming System

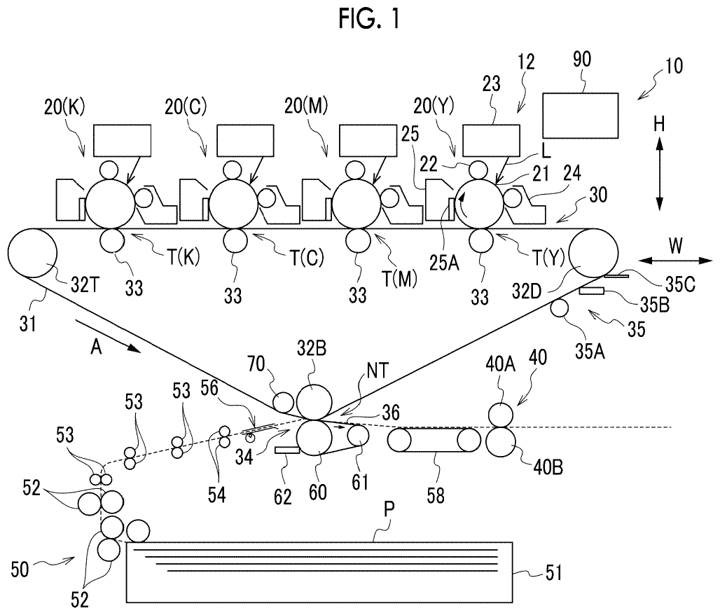

FIG. 1 is a schematic view showing a configuration of an image forming system 10 according to a first exemplary embodiment as seen from a front side. As shown in FIG. 1, an image forming system 10 includes an image forming unit 12 that forms an image on paper P by an electrophotographic method, a transport device 50 that transports the paper P, and a control unit 90 that controls the operation of each unit of the image forming system 10. The paper P is an example of a medium.

### Transport Device

As shown in FIG. 1, the transport device 50 includes an accommodation portion 51 in which the paper P is accommodated, and a plurality of transport rolls 52 and 53 that transport the paper P from the accommodation portion 51 to a secondary transfer position NT. In addition, the transport device 50 includes the guide portion 56 disposed on the upstream side of the paper P in the transport direction with respect to the secondary transfer position NT, and a registration roll 54 disposed on the upstream side of the guide portion 56 in the transport direction of the paper P. The registration roll 54 adjusts the timing of transporting the paper P to the secondary transfer position NT. The guide portion 56 guides the paper P to the secondary transfer position NT on the downstream side in the transport direction of the registration roll 54. Further, the transport device 50 includes a transport belt 58 that transports the paper P from the secondary transfer position NT to a fixing device 40 to be described below.

### Image Forming Unit

The image forming unit 12 includes a toner image forming unit 20 that forms a toner image, a transfer device 30 that transfers the toner image formed by the toner image forming unit 20 to the paper P, and a fixing device 40 that heats and presses the toner image transferred to the paper P to fix the toner image to the paper P.

A plurality of the toner image forming units 20 are provided to form toner images for each color. For example, the toner image forming units 20 for a total of four colors including yellow (Y), magenta (M), cyan (C), and black (K) are provided. The toner image forming units 20 for the respective colors are disposed in the order of yellow (Y), magenta (M), cyan (C), and black (K) from the upstream side to the downstream side in the transport direction of the intermediate transfer belt 31 which will be described below.

(Y), (M), (C), and (K) shown in FIG. 1 indicate constituent parts corresponding to the respective colors. In the description of the present specification, (Y), (M), (C), and (K) may be described as Y, M, C, and K without parentheses.

### Toner Image Forming Unit

The toner image forming units 20 for the respective colors have the basically same configuration except for a toner to be used. Specifically, the toner image forming units 20 for the respective colors includes a photosensitive drum 21, a charger 22, an exposure device 23, a developing device 24, and a cleaning device 25. The photosensitive drum 21 includes a photosensitive layer on a surface thereof and rotates in a clockwise direction indicated by an arrow. The charger 22 charges the photosensitive drum 21. The exposure device 23 exposes the photosensitive drum 21 charged by the charger 22 to form an electrostatic latent image on the photosensitive drum 21. In addition, the developing device 24 develops the electrostatic latent image formed on the photosensitive drum 21 by the exposure device 23 to form the toner image. The cleaning device 25 includes a blade 25A, and the blade 25A removes the toner remaining on the surface of the photosensitive drum 21 after the transfer of the toner image to the transfer device 30. In FIG. 1, since the respective constituent members are the same except for the toner in the toner image forming units 20 for the respective colors, the illustrations of (Y), (M), (C), and (K) are omitted.

The charger 22 charges the surface (photosensitive layer) of the photosensitive drum 21 with a negative polarity, for example. In the surface of the photosensitive drum 21 charged negatively, a portion irradiated with the exposure light L by the exposure device 23 exhibits positive polarity, and an electrostatic latent image is formed on the surface of the photosensitive drum 21. Then, the negatively charged toner in the developing device 24 adheres to the electrostatic latent image exhibiting positive polarity, and the electrostatic latent image is developed. In this way, the toner image is formed on the surface (outer peripheral surface) of the photosensitive drum 21. The blade 25A comes into contact with the surface of the photosensitive drum 21, and scrapes off the toner remaining on the surface of the photosensitive drum 21.

### Transfer Device

The transfer device 30 includes an intermediate transfer belt 31, a primary transfer roll 33, and a secondary transfer unit 34. The intermediate transfer belt 31 is an example of an intermediate transfer body. The transfer device 30 superimposes the toner image on the photosensitive drums 21 for the respective colors on the intermediate transfer belt 31 to perform primary transfer, and performs secondary transfer of the superimposed toner image to the paper P at the secondary transfer position NT. The secondary transfer unit 34 includes a secondary transfer belt 36.

As shown in FIG. 1, the intermediate transfer belt 31 has an endless shape and is wound around the driving roll 32D, the tension applying roll 32T, the pre-roll 70, and the inner roll 32B to determine the posture. The driving roll 32D, the tension applying roll 32T, the pre-roll 70, and the inner roll 32B are examples of a plurality of rolls and come into contact with the inside of the endless intermediate transfer belt 31. The inner roll 32B is an example of a transfer rotating body. The pre-roll 70 is an example of a rotating member. As an example, the intermediate transfer belt 31 has an inverted obtuse triangle shape posture that is long in the device width direction in front view. It is noted that the intermediate transfer belt 31 may include another roll around which the intermediate transfer belt 31 is wound.

The driving roll 32D causes the intermediate transfer belt 31 to circulate in a direction of an arrow A by a motive power of a motor (not illustrated). The intermediate transfer belt 31 circulates in the arrow A direction to transport the toner image primarily transferred to the outer peripheral surface to the secondary transfer position NT. As an example, the driving roll 32D is disposed on the upstream side of the four primary transfer rolls 33 in the circulation direction of the intermediate transfer belt 31. The tension applying roll 32T applies tension to the intermediate transfer belt 31.

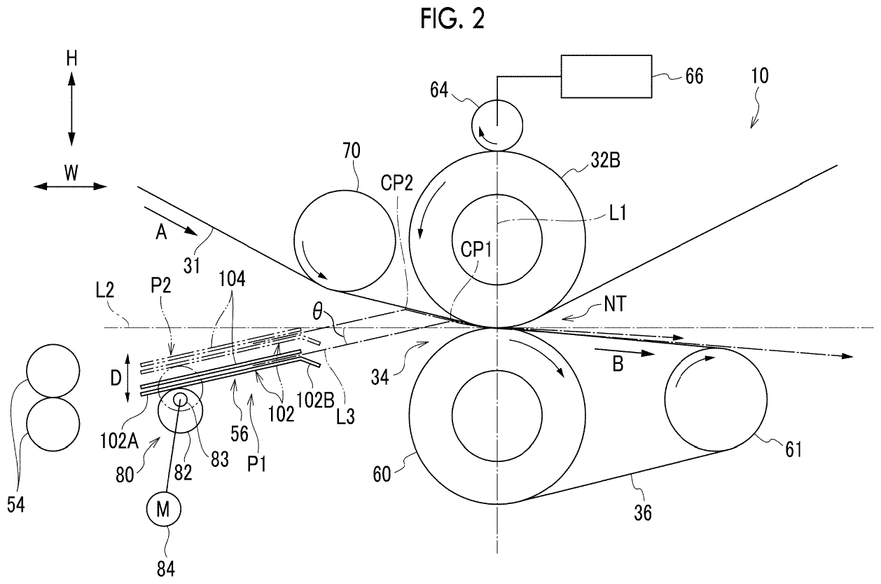

The pre-roll 70 is disposed on the downstream side of the primary transfer position T and the tension applying roll 32T in the circulation direction of the intermediate transfer belt 31 and on the upstream side of the inner roll 32B. The pre-roll 70 comes into contact with the inside of the intermediate transfer belt 31 on the upstream side of the secondary transfer position NT. The pre-roll 70 comes into contact with the intermediate transfer belt 31 to push the intermediate transfer belt 31 outward with respect to a straight line (not shown) connecting a tangent line of the tension applying roll 32T and a tangent line of the inner roll 32B (refer to FIG. 2). As a result, the pre-roll 70 applies tension to the intermediate transfer belt 31 at a position where the intermediate transfer belt 31 faces the secondary transfer position NT, and rotation of the intermediate transfer belt 31 is stable.

In addition, the inner roll 32B is a roll that faces the secondary transfer roll 60 described below. The intermediate transfer belt 31 has the inverted obtuse triangle shaped posture as described above, and the apex of the intermediate transfer belt 31, which is on a lower end side and forms an obtuse angle, is wound around the inner roll 32B. The intermediate transfer belt 31 comes into contact with the photosensitive drums 21 for the respective colors from below, in an upper side portion extending in the apparatus width direction with the posture described above.

A cleaning device 35 that removes the toner remaining on the intermediate transfer belt 31 is provided on the downstream side of the secondary transfer position NT and on the upstream side of the primary transfer positions T (K) in the circulation direction of the intermediate transfer belt 31. As an example, the cleaning device 35 includes a cleaning brush 35A, a blade 35B, and a scraper 35C. The cleaning brush 35A rotates while coming into contact with the surface of the intermediate transfer belt 31 to remove the toner on the surface of the intermediate transfer belt 31. The blade 35B comes into contact with the intermediate transfer belt 31 and scrapes off the toner on the surface of the intermediate transfer belt 31. The scraper 35C comes into contact with the intermediate transfer belt 31 and scrapes off the toner on the surface of the intermediate transfer belt 31 that has not been completely removed by the cleaning brush 35A and the blade 35B.

As illustrated in FIG. 1, the primary transfer rolls 33 are rolls that transfer the toner images of the respective photosensitive drums 21 to the intermediate transfer belt 31, and are disposed on an inside of the intermediate transfer belt 31. The primary transfer rolls 33 are disposed to face the corresponding photosensitive drums 21 for the respective colors with the intermediate transfer belt 31 interposed therebetween. In addition, a primary transfer voltage having a polarity opposite to the toner polarity is applied to the primary transfer rolls 33 by a power supply unit (not shown). By applying the primary transfer voltage, the toner images formed on the photosensitive drums 21 are transferred to the intermediate transfer belt 31 at the primary transfer positions T between the photosensitive drums 21 and the primary transfer rolls 33.

As shown in FIGS. 1 and 2, the secondary transfer unit 34 includes a secondary transfer belt 36, and a secondary transfer roll 60 and a driven roll 61 that support the secondary transfer belt 36 in a rotatable manner. The secondary transfer roll 60 is an example of a counter rotating body. In addition, the secondary transfer unit 34 includes an inner roll 32B facing the secondary transfer roll 60 via the intermediate transfer belt 31 and the secondary transfer belt 36, and a contact roll 64 that comes into contact with the inner roll 32B to supply power to the inner roll 32B (refer to FIG. 2). A power supply device 66 is connected to the contact roll 64 (refer to FIG. 2). As an example, the contact roll 64 is rotationally driven in accordance with the rotation of the inner roll 32B. Although not shown in the drawing, the secondary transfer roll 60 is grounded. Further, the secondary transfer unit 34 includes a cleaning device 62 that removes the toner on the surface of the secondary transfer belt 36 (refer to FIG. 1). In the secondary transfer unit 34, a secondary transfer electric field is formed by applying a secondary transfer voltage to the inner roll 32B from the power supply device 66 via the contact roll 64. By the transfer electric field, the toner images superimposed on the intermediate transfer belt 31 are transferred onto the paper P that is transported between the intermediate transfer belt 31 and the secondary transfer belt 36.

The secondary transfer belt 36 is formed in an endless shape, and is wound around the secondary transfer roll 60 and the driven roll 61. The secondary transfer roll 60 is rotationally driven by a motor (not shown). The driven roll 61 is driven in accordance with the rotation of the secondary transfer belt 36.

The secondary transfer roll 60 is disposed to interpose the intermediate transfer belt 31 and the secondary transfer belt 36 between the secondary transfer roll 60 and the inner roll 32B, and the secondary transfer belt 36 and the intermediate transfer belt 31 come into contact with each other with a predetermined load. A position between the secondary transfer belt 36 and the intermediate transfer belt 31 that come into contact with each other is referred to as a secondary transfer position NT. The paper P is supplied to the secondary transfer position NT at a predetermined timing from the accommodation portion 51. As the secondary transfer roll 60 is rotationally driven, the secondary transfer belt 36 rotates in a direction of an arrow B.

As an example, the secondary transfer roll 60 is configured with a foaming roll in which a conductive resin is dispersed. As an example, the driven roll 61 is configured with a metal roll. As an example, the inner roll 32B has a configuration in which a conductive material such as carbon is dispersed in a foaming roll.

For example, in a case where the toner image on the surface of the intermediate transfer belt 31 is transferred to the paper P, a negative voltage is applied to the inner roll 32B by the power supply device 66 via the contact roll 64. As a result, a potential difference is generated between the inner roll 32B and the secondary transfer roll 60. That is, by applying a negative voltage to the inner roll 32B, a secondary transfer voltage (positive voltage) having a polarity opposite to the toner polarity is indirectly applied to the secondary transfer roll 60 forming the counter electrode of the inner roll 32B. As a result, the toner image of the negative electrode is transferred from the intermediate transfer belt 31 to the paper P passing through the secondary transfer position NT. As an example, the secondary transfer voltage is determined depending on the type of the paper P and the width of the paper P in a direction that is orthogonal to the transport direction.

The cleaning device 62 is a blade that comes into contact with the secondary transfer belt 36, and removes the toner attached to the secondary transfer belt 36.

### Fixing Device

As shown in FIG. 1, the fixing device 40 includes a heating roll 40A and a pressurizing roll 40B that is pressed against the heating roll 40A. The paper P onto which the toner images are transferred passes through a nip portion between the heating roll 40A and the pressurizing roll 40B, and thus, the toner images are fixed to the paper P.

### Operation of Image Forming System

Next, the operation of the image forming system 10 will be described.

In a case where the operation of the image forming system 10 is started, toner images for respective colors are formed on the surface of the photosensitive drum 21 by the steps of charging, exposure, and development in the toner image forming units 20 for the respective color (Y), (M), (C), and (K). Specifically, the photosensitive drum 21 is charged by the charger 22, and the photosensitive drum 21 is exposed by the exposure device 23, so that a latent image is formed on the surface of the photosensitive drum 21. Furthermore, the latent image of the photosensitive drum 21 is developed by the toner by the developing device 24. As a result, in the toner image forming unit 20 for respective colors, a toner image for each color is formed on the surface of the photosensitive drum 21.

In the image forming system 10, a primary transfer voltage is applied to the primary transfer roll 33 of each color. In addition, the driving roll 32D causes the intermediate transfer belt 31 to circulate in the direction of the arrow A. As a result, the toner images for respective colors formed on the photosensitive drum 21 for the respective colors are primarily transferred to the intermediate transfer belt 31 in an overlapping manner.

On the other hand, the paper P accommodated in the accommodation portion 51 is transported to the secondary transfer position NT by the transport device 50 at a timing at which the portion of the intermediate transfer belt 31 to which the toner images for respective colors are primarily transferred reach the secondary transfer position NT. Then, by applying the secondary transfer voltage to the inner roll 32B, a transfer electric field is formed between the inner roll 32B and the secondary transfer roll 60, and the toner images for respective colors held by the intermediate transfer belt 31 are transferred to the paper P.

Further, the paper P on which the toner images for respective colors are transferred is transported by the transport device 50 toward the fixing device 40. Then, the fixing device 40 fixes the toner images for respective colors on the paper P passing between the heating roll 40A and the pressurizing roll 40B, and the image is formed on the paper P. Accordingly, the image forming operation is ended.

### Configuration of Moving Guide Portion of Image Forming System

Next, a configuration in which the guide portion 56, which is a main portion of the image forming system 10, is moved will be described.

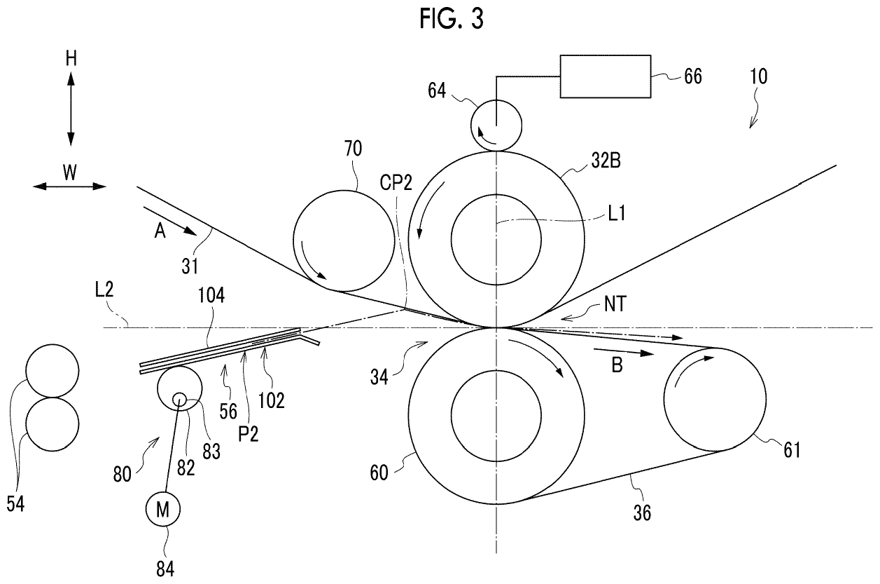

As shown in FIGS. 2 and 3, the image forming system 10 includes a guide portion 56 that guides the paper P to the secondary transfer position NT, and a movement portion 80 that moves the guide portion 56 in a direction approaching or separating from the intermediate transfer belt 31.

### Guide Portion

As shown in FIGS. 2 and 3, the guide portion 56 includes a pair of plate-like portions 102 and 104 disposed at intervals on both sides of the paper P passing through. One plate-like portion 102 is disposed on a side far from the intermediate transfer belt 31, and the other plate-like portion 104 is disposed on a side close to the intermediate transfer belt 31. In the first exemplary embodiment, one plate-like portion 102 is disposed on the lower side in the up-down direction, and the other plate-like portion 104 is disposed on the upper side in the up-down direction. The paper P is guided to the secondary transfer position NT by passing between the pair of plate-like portions 102 and 104.

As an example, the plate-like portion 102 includes a planar portion 102A and a bent portion 102B that is bent in a direction separated from the plate-like portion 104 from a downstream end portion of the planar portion 102A. The lower surface of the paper P can come into contact with the planar portion 102A of the plate-like portion 102. The planar portion 102A of the plate-like portion 102 is an example of a medium contact portion (that is, a paper contact portion) which comes into contact with the paper P. As an example, the plate-like portion 104 has a planar shape, and the upper surface of the paper P can come into contact with the plate-like portion 104. As an example, the planar portion 102A of the plate-like portion 102 and the plate-like portion 104 are disposed in parallel.

The planar portion 102A, which is the paper contact portion in the guide portion 56, is disposed in a direction intersecting a line L1 connecting the center of the inner roll 32B and the center of the secondary transfer roll 60. As an example, the planar portion 102A of the plate-like portion 102 and the plate-like portion 104 are disposed to be inclined to have an upward gradient toward the secondary transfer position NT. For example, an angle between the virtual tangent line L2 of the inner roll 32B that is orthogonal to the line L1 and the intermediate virtual extension line L3 along the planar portion 102A of the plate-like portion 102 and the plate-like portion 104 is θ.

### Movement Portion

As shown in FIGS. 2 and 3, the movement portion 80 includes a cam 82 that comes into contact with a lower surface (a surface opposite to the plate-like portion 104) of the planar portion 102A of the plate-like portion 102, and a motor 84 that rotates a shaft portion 83 of the cam 82. The driving of the motor 84 is controlled by the control unit 90.

The movement portion 80 moves the entire planar portion 102A in the guide portion 56 with the posture in the direction intersecting the line L1 with respect to the intermediate transfer belt 31 according to the type of the paper P. As an example, the pair of plate-like portions 102 and 104 are integrally supported by a frame (not shown). The movement portion 80 rotates the cam 82 to integrally move the pair of plate-like portions 102 and 104 in an up-down direction (direction of arrow D). Specifically, the guide portion 56 is moved to the first position P1 (refer to FIG. 2) far from the intermediate transfer belt 31 by bringing a portion of the cam 82 having a small diameter into contact with the plate-like portion 102 by the rotation of the cam 82. In addition, the guide portion 56 is moved to the second position P2 (refer to FIG. 3) close to the intermediate transfer belt 31 by bringing a portion of the cam 82 having a large diameter into contact with the plate-like portion 102 by the rotation of the cam 82. In the first exemplary embodiment, the movement portion 80 moves the guide portion 56 to the first position P1 on a lower side in the up-down direction and the second position P2 on an upper side in the up-down direction.

The type of the paper P includes, for example, a difference in thickness of the paper P, a difference in smoothness of the paper P, and the like. As an example, in a case where the paper P is a paper P having a thickness larger than the predetermined thickness, the movement portion 80 moves the entire planar portion 102A in the guide portion 56 in a direction approaching the intermediate transfer belt 31 as compared with a case where the paper has the predetermined thickness. In a case where a film medium is used instead of the paper P, the movement portion 80 may move the entire planar portion 102A in the guide portion 56 in a direction approaching the intermediate transfer belt 31, as compared with a case of the paper having the predetermined thickness.

As an example, in a case where the paper P is a paper P having a surface smoother than a predetermined smoothness, the movement portion 80 moves the entire planar portion 102A in the guide portion 56 in a direction separating from the intermediate transfer belt 31 as compared with a case where the paper has the predetermined smoothness.

In addition, the movement portion 80 moves the entire planar portion 102A in the guide portion 56 in a direction approaching or separating from the intermediate transfer belt 31 in accordance with the secondary transfer voltage.

As an example, in a case where the secondary transfer voltage is higher than a reference voltage, the movement portion 80 moves the entire planar portion 102A in the guide portion 56 in a direction approaching the intermediate transfer belt 31, as compared with a case where the secondary transfer voltage is equal to or lower than the reference voltage. The reference voltage is set in advance, for example, according to the thickness of the paper P.

As an example, the movement portion 80 moves the guide portion 56 with respect to the intermediate transfer belt 31 while maintaining a posture in which an angle θ between the virtual tangent line L2 of the inner roll 32B that is orthogonal to the line L1 and the intermediate virtual extension line L3 along the planar portion 102A of the plate-like portion 102 and the plate-like portion 104 is the same. For example, in a case where the guide portion 56 moves in a direction approaching the intermediate transfer belt 31 and in a case where the guide portion 56 moves in a direction separating from the intermediate transfer belt 31, the angle between the virtual tangent line L2 of the inner roll 32B that is orthogonal to the line L1 and the planar portion 102A of the guide portion 56 is the same. For example, the movement is performed such that the angle between the virtual tangent line L2 of the inner roll 32B that is orthogonal to the line L1 and the planar portion 102A in the guide portion 56 falls within a range of ±4 degrees from the angle before the movement. That is, the same angle means that the movement is performed to fall within a range of ±4 degrees from the angle before the movement. The angle between the virtual tangent line L2 of the inner roll 32B that is orthogonal to the line L1 and the planar portion 102A of the guide portion 56 is preferably in a range of ±4 degrees, more preferably in a range of ±3 degrees, and still more preferably in a range of ±2 degrees from, for example, the angle before movement. In the first exemplary embodiment, the angle θ between the virtual tangent line L2 of the inner roll 32B that is orthogonal to the line L1 and the intermediate virtual extension line L3 along the planar portion 102A of the plate-like portion 102 and the plate-like portion 104 is set to fall in a range of ±4 degrees from the angle before movement.

As an example, in a state in which the guide portion 56 is moved to the first position P1, the paper P guided by the guide portion 56 comes into contact with the intermediate transfer belt 31 at a contact point CP1 (refer to FIG. 2). In addition, as an example, in a state in which the guide portion 56 is moved to the second position P2, the paper P guided by the guide portion 56 comes into contact with the intermediate transfer belt 31 at a contact point CP2 (refer to FIG. 3). The contact points CP1 and CP2 at which the paper P guided by the guide portion 56 comes into contact with the intermediate transfer belt 31 are on the downstream side of the pre-roll 70 in the circulation direction of the intermediate transfer belt 31. In the first exemplary embodiment, the contact points CP1 and CP2 at which the paper P guided by the guide portion 56 comes into contact with the intermediate transfer belt 31 are set between the contact portion of the pre-roll 70 and the inner roll 32B in the circulation direction of the intermediate transfer belt 31.

### Problem of Image Forming System in Comparative Example

Here, the problems of an image forming system of a comparative example will be described.

Although not shown, in an image forming system of a first comparative example, the toner image on the intermediate transfer belt is transferred to the paper P at the secondary transfer position formed by the secondary transfer roll and the inner roll. In this method, in a case where a gap is generated between the intermediate transfer belt and the paper P immediately before the secondary transfer position, discharge occurs, which leads to poor image quality (image quality defect) such as white spots. In particular, in a case where a medium such as paper or a film having a thickness larger than a predetermined thickness is used as a medium requiring a high voltage for the secondary transfer, discharge is likely to occur.

On the other hand, although not shown, in an image forming system of a second comparative example, the guide portion is rotated around the upstream side end portion of the guide portion on the upstream side of the secondary transfer position in the transport direction of the paper P. For example, in a case where the guide portion is rotated around the upstream side end portion of the guide portion, the downstream end portion of the guide portion is rotated in a direction separating from the intermediate transfer belt. As a result, the entry angle of the paper P into the intermediate transfer belt is increased before the rotation of the guide portion, and the discharge is suppressed.

However, in the image forming system of a second comparative example, the transportability of the thick paper P is changed by rotating the guide portion, and the paper P may be damaged by increasing the entry angle of the paper P into the intermediate transfer belt. The occurrence of damage on the paper P may cause poor image quality (image quality defect).

In addition, in a case where the guide portion is rotated around the upstream side end portion of the guide portion and the downstream end portion of the guide portion is rotated in a direction approaching the intermediate transfer belt, the gap between the paper P and the intermediate transfer belt is reduced, and thus the toner on the paper having a smooth surface may scatter.

Therefore, in the image forming system of the second comparative example, there is room for improvement in suppressing the occurrence of poor image quality (image quality defect).

### Actions and Effects

Next, actions of the first exemplary embodiment will be described.

The image forming system 10 according to the first exemplary embodiment includes an endless intermediate transfer belt 31, an inner roll 32B, a secondary transfer roll 60, a guide portion 56, and a movement portion 80. The intermediate transfer belt 31 moves in the circulation direction and transports the toner image that is primarily transferred to the outer peripheral surface. The inner roll 32B rotates and comes into contact with the intermediate transfer belt 31, and transfers the toner image of the intermediate transfer belt 31 to the paper P at the secondary transfer position NT facing the intermediate transfer belt 31. The secondary transfer roll 60 rotates and faces the inner roll 32B while interposing the intermediate transfer belt 31, and a potential difference is formed between the secondary transfer roll 60 and the inner roll 32B. The guide portion 56 is provided on the upstream side of the paper P in the transport direction with respect to the secondary transfer position NT, and guides the paper P to the secondary transfer position NT. The movement portion 80 moves the entire planar portion 102A in the guide portion 56 in a direction approaching or separating from the intermediate transfer belt 31 while maintaining a posture in a direction intersecting the line L1 connecting the center of the inner roll 32B and the center of the secondary transfer roll 60, according to the type of the paper P.

In the image forming system 10, as described above, the occurrence of discharge can be suppressed by moving the entire planar portion 102A in the guide portion 56 in the direction approaching or separating from the intermediate transfer belt 31 according to the type of the paper P. In addition, the entire planar portion 102A in the guide portion 56 is moved in a direction approaching or separating from the intermediate transfer belt 31 while maintaining the posture in the direction intersecting the line L1. Accordingly, the transportability of the thick paper P is less likely to be changed, and the paper P is less likely to be damaged, compared to the case where the entry angle of the paper P into the intermediate transfer belt is changed.

Therefore, in the image forming system 10, the occurrence of the image quality defect is suppressed, as compared with a case where only the one end portion side of the medium in the transport direction of the guide portion is moved in the direction approaching or separating from the intermediate transfer body.

In addition, in the image forming system 10, in a case where the paper P is the paper P having a thickness larger than the predetermined thickness, the movement portion 80 moves the entire planar portion 102A in the guide portion 56 in a direction approaching the intermediate transfer belt 31 as compared with the paper having the predetermined thickness. In addition, in a case where a film medium is used instead of the paper P, the movement portion 80 moves the entire planar portion 102A in the guide portion 56 in a direction approaching the intermediate transfer belt 31, as compared with a case of the paper having the predetermined thickness. Therefore, in the image forming system 10, the occurrence of the image quality defect is suppressed as compared with a case where the position of the guide portion is not changed in a case where the paper P is the paper having a thickness larger than a predetermined thickness or a film medium.

In addition, in the image forming system 10, in a case where the paper P is a paper P having a surface smoother than a predetermined smoothness, the movement portion 80 moves the entire planar portion 102A in the guide portion 56 in a direction separating from the intermediate transfer belt 31 as compared with a case where the paper has the predetermined smoothness. For example, in the paper P having a smooth surface, in a case where the interval between the paper P and the intermediate transfer belt 31 is small, the toner image of the intermediate transfer belt 31 may rub against the paper P, and toner scattering may occur. By increasing the interval between the paper P and the intermediate transfer belt 31, the toner image of the intermediate transfer belt 31 is less likely to rub against the paper P. Therefore, in the image forming system 10, the occurrence of image quality defect due to toner scattering is suppressed, as compared with a case where the position of the guide portion does not change in a case where the paper P has a surface smoother than the predetermined smoothness.

In addition, in the image forming system 10, the movement portion 80 moves the entire planar portion 102A in the guide portion 56 in a direction approaching or separating from the intermediate transfer belt in accordance with the secondary transfer voltage applied to the inner roll 32B. Accordingly, the interval between the intermediate transfer belt 31 and the paper P can be adjusted in accordance with the secondary transfer voltage applied to the inner roll 32B. Therefore, in the image forming system 10, the occurrence of the image quality defect is suppressed, as compared with a case where the position of the guide portion is not changed due to the change in the secondary transfer voltage.

In addition, in the image forming system 10, in a case where the secondary transfer voltage is higher than the reference voltage, the movement portion 80 moves the entire planar portion 102A in the guide portion 56 in a direction approaching the intermediate transfer belt 31, as compared with a case where the secondary transfer voltage is equal to or lower than the reference voltage. For example, in a case where the secondary transfer voltage is higher than the reference voltage, the interval between the intermediate transfer belt 31 and the paper P is reduced. In addition, in a case where the secondary transfer voltage is equal to or less than the reference voltage, the interval between the intermediate transfer belt 31 and the paper P is increased. For example, in a case of the paper P having a thickness larger than the predetermined thickness or a film medium, the secondary transfer voltage may be higher than the reference voltage in many cases. In a case where the secondary transfer voltage is higher than the reference voltage, a pre-discharge is likely to occur between the intermediate transfer belt 31 and the paper P. By reducing the interval between the intermediate transfer belt 31 and the paper P, the pre-discharge is less likely to occur. Therefore, in the image forming system 10, the occurrence of the image quality defect is suppressed, as compared with a case where the position of the guide portion is not changed when the secondary transfer voltage is higher than the reference voltage.

In addition, in the image forming system 10, the pre-roll 70 that comes into contact with the inside of the intermediate transfer belt 31 is provided on a downstream side of the primary transfer position T in the circulation direction of the intermediate transfer belt 31 and is on an upstream side of the secondary transfer roll 60 in the circulation direction of the intermediate transfer belt 31. Further, the contact points CP1 and CP2 at which the paper P guided by the guide portion 56 comes into contact with the intermediate transfer belt are on the downstream side of the pre-roll 70 in the circulation direction of the intermediate transfer belt 31. Accordingly, the paper P can be transported without bending the paper P as much as possible on the upstream side of the secondary transfer position NT, and the paper P is less likely to be bent. Therefore, in the image forming system 10, the occurrence of damage on the paper P is suppressed, as compared with a case where the contact points at which the paper P guided by the guide portion comes into contact with the intermediate transfer belt are downstream side of the primary transfer position and upstream side of the pre-roll in the circulation direction of the intermediate transfer belt.

In addition, in the image forming system 10, in a case where the guide portion 56 is moved in a direction approaching and separating from the intermediate transfer belt 31, the guide portion 56 is moved such that the angle between the virtual tangent line L2 of the inner roll 32B that is orthogonal to the line L1 and the planar portion 102A in the guide portion 56 falls in a range of ±4 degrees from the angle before the movement. Accordingly, the entry angle of the paper P into the intermediate transfer belt 31 is unlikely to change largely, the transportability of the paper P is less likely to be changed, and the paper P is less likely to be bent. Therefore, in the image forming system 10, in a case where the guide portion is moved in a direction approaching the intermediate transfer belt and a case where the guide portion is moved in a direction separating from the intermediate transfer belt, the occurrence of damage on the paper P is suppressed as compared with a case where the angle between the virtual tangent line and the paper contact portion in the guide portion is changed.

### Second Exemplary Embodiment

Next, an image forming system according to a second exemplary embodiment will be described. The identical components to the configurations of the first exemplary embodiment described above will be denoted the identical reference numerals and the description thereof will be omitted.

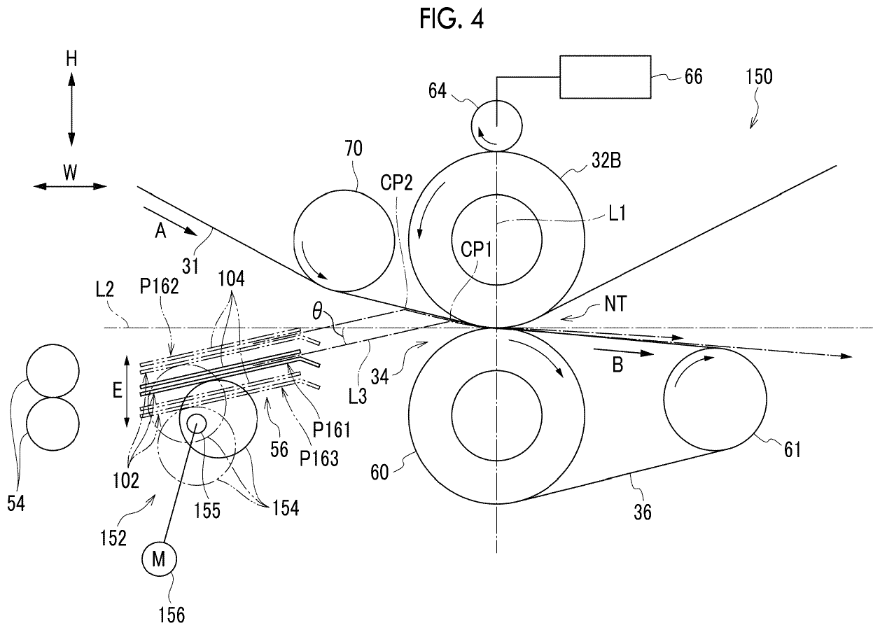

As shown in FIG. 4, in an image forming system 150 of the second exemplary embodiment, the movement range of the guide portion 56 to be moved by the movement portion 152 is different from the image forming system 10 of the first exemplary embodiment.

The movement portion 152 includes a cam 154 that comes into contact with a lower surface (surface opposite to the plate-like portion 104) of the planar portion 102A of the plate-like portion 102, and a motor 156 that rotates a shaft portion 155 of the cam 154. The movement portion 152 moves the guide portion 56 in a direction approaching or separating from the intermediate transfer belt 31 by rotating the cam 154.

The movement portion 152 moves the entire planar portion 102A in the guide portion 56 in a direction approaching or separating from the intermediate transfer belt 31 while maintaining the posture in a direction intersecting the line L1, according to the type of the paper P. As an example, the movement portion 152 moves the guide portion 56 in the up-down direction (the direction of the arrow E) by rotating the cam 154 to move the guide portion 56 to the first position P161, the second position P162, and the third position P163. The first position P161 is a reference position in the middle in the up-down direction. The second position P162 is a position on the upper side (+H direction) of the first position P161 and is a position close to the intermediate transfer belt 31. The third position P163 is a position on the lower side (−H direction) of the first position P161 and is a position far from the intermediate transfer belt 31.

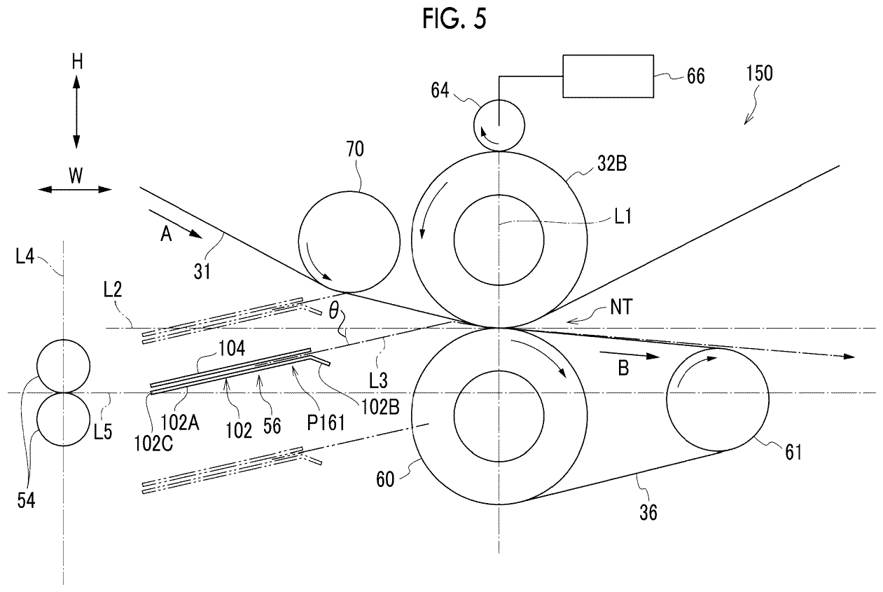

As shown in FIG. 5, at the first position P161, the upstream side end portion 102C of the planar portion 102A of the plate-like portion 102 in the guide portion 56 is disposed on a line L5 that is orthogonal to a line L4 connecting the centers of upper and lower registration rolls 54. The planar portion 102A is a portion which comes into contact with the paper P. The line L4 connecting the centers of the upper and lower registration rollers 54 is a tangent line of the contact portions of the upper and lower registration rolls 54.

In FIG. 5, the position of the guide portion 56, which is not preferable, in the up-down direction is indicated by a two-dot chain line. In a case where the guide portion 56 is moved too far upward in the up-down direction, the paper P guided by the guide portion 56 comes into contact with the intermediate transfer belt 31 on the pre-roll 70, which is not preferable. In addition, in a case where the guide portion 56 is moved too far in the up-down direction, the paper P guided by the guide portion 56 comes into contact with the secondary transfer belt 36 on the secondary transfer roll 60, which is not preferable. Other configurations of the image forming system 150 are the same as the image forming system 10 according to the first exemplary embodiment.

In the image forming system 150 of the second exemplary embodiment, with the same configuration of the image forming system 10 of the first exemplary embodiment, the same actions and effects are obtained.

### Third Exemplary Embodiment

Next, an image forming system according to a third exemplary embodiment will be described. It should be noted that the identical reference numerals are assigned to the identical components to the first and second exemplary embodiments described above, and the description thereof will be omitted.

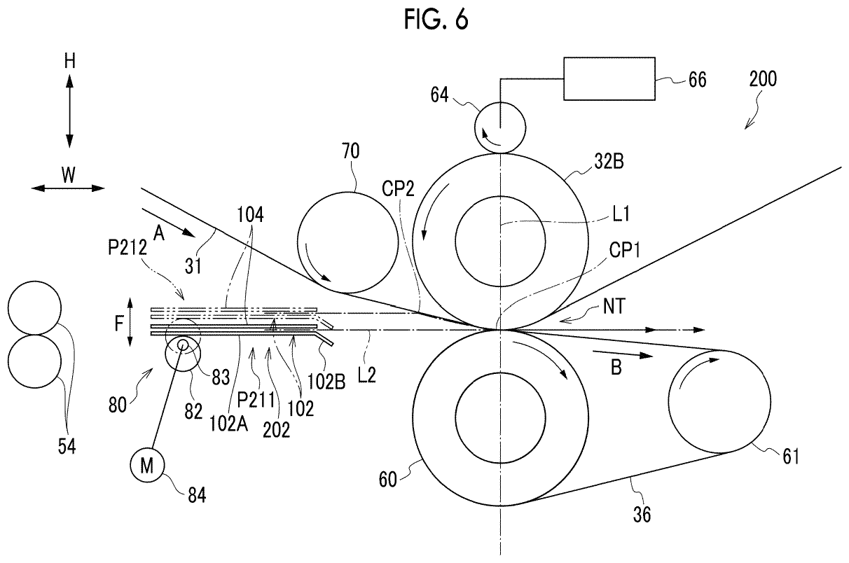

As shown in FIG. 6, in an image forming system 200 of the third exemplary embodiment, the inclination of a guide portion 202 with respect to the horizontal direction is different from the image forming system 10 of the first exemplary embodiment.

The guide portion 202 includes a pair of plate-like portions 102 and 104. The planar portion 102A of the plate-like portion 102 in the guide portion 202 is disposed in a direction (for example, a direction of 90 degrees) intersecting a line L1 connecting the center of the inner roll 32B and the center of the secondary transfer roll 60. That is, the planar portion 102A of the plate-like portion 102 in the guide portion 202 is disposed along the virtual tangent line L2 of the inner roll 32B that is orthogonal to the line L1 connecting the center of the inner roll 32B and the center of the secondary transfer roll 60.

The movement portion 80 includes a cam 82 that comes into contact with a lower surface (surface opposite to the plate-like portion 104) of the planar portion 102A of the plate-like portion 102, and a motor 84 that rotates a shaft portion 83 of the cam 82. The movement portion 80 moves the entire planar portion 102A in the guide portion 56 with respect to the intermediate transfer belt 31 while maintaining a posture in a direction (for example, a direction of 90 degrees) intersecting the line L1 connecting the center of the inner roll 32B and the center of the secondary transfer roll 60, according to the type of the paper P. In other words, the movement portion 80 moves the entire planar portion 102A in the guide portion 56 with respect to the intermediate transfer belt 31 while maintaining the posture in a direction along the virtual tangent line L2 of the inner roll 32B that is orthogonal to the line L1 connecting the center of the inner roll 32B and the center of the secondary transfer roll 60.

As an example, the transport direction of the paper P guided by the guide portion 202 is a direction along a virtual tangent line L2 of the inner roll 32B that is orthogonal to a line L1 connecting the center of the inner roll 32B and the center of the secondary transfer roll 60. The planar portion 102A as an example of the medium contact portion of the plate-like portion 102 in the guide portion 202 has a planar shape in a side view.

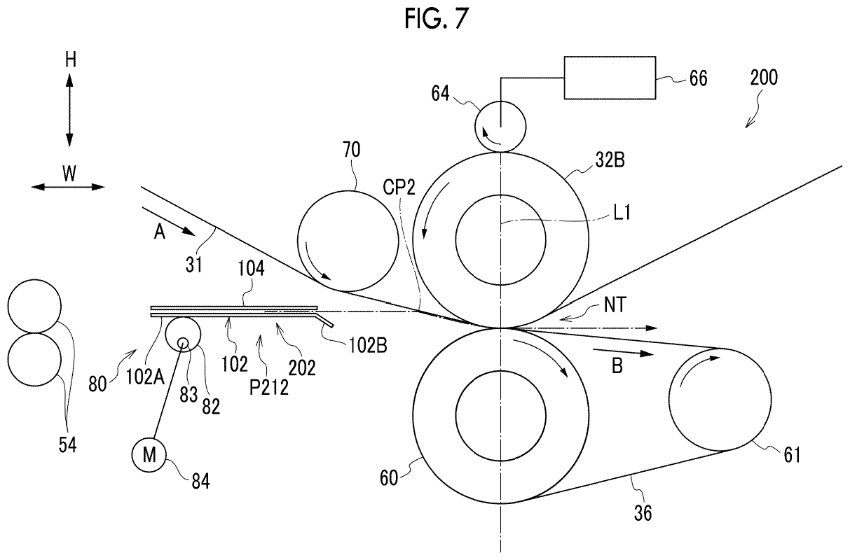

As an example, the movement portion 80 moves the guide portion 202 in the up-down direction (the direction of the arrow F) by rotating the cam 82. The movement portion 80 moves the guide portion 202 to a first position P211 (refer to FIG. 6) distant from the intermediate transfer belt 31 by bringing a portion of the cam 82 having a small diameter into contact with the plate-like portion 102. In addition, the movement portion 80 moves the guide portion 202 to a second position P212 (refer to FIG. 7) close to the intermediate transfer belt 31 by bringing a portion of the cam 82 having a large diameter into contact with the plate-like portion 102. In the first exemplary embodiment, the movement portion 80 moves the guide portion 56 to the first position P211 on a lower side in the up-down direction and the second position P212 on an upper side in the up-down direction. In addition, other configurations of the image forming system 200 are the same as the image forming system 10 according to the first exemplary embodiment.

In the image forming system 200 of the third exemplary embodiment, in addition to the actions and effects of the same configuration as the image forming system 10 of the first exemplary embodiment, the following actions and effects can be obtained.

In the image forming system 200, the transport direction in which the paper P is guided by the guide portion 202 is a direction along a virtual tangent line L2 of the secondary transfer roll 60 that is orthogonal to a line L1 connecting the center of the inner roll 32B and the center of the secondary transfer roll 60. Accordingly, in a case where the paper P guided by the guide portion 202 is transported to the secondary transfer position NT, the paper P is transported in a shape close to a straight line without being substantially curved. Therefore, the paper P is not likely to be bent. Therefore, in the image forming system 200, the occurrence of damage on the paper P is suppressed, as compared with a case where the transport direction of the paper P guided by the guide portion is a direction intersecting the virtual tangent line of the secondary transfer roll that is orthogonal to the line connecting the center of the opposing roll and the center of the secondary transfer roll.

In addition, in the image forming system 200, the planar portion 102A of the plate-like portion 102 in the guide portion 202, which comes into contact with the paper P, has a planar shape in a side view. Therefore, in the image forming system 200, the occurrence of damage on the paper P is suppressed as compared with a case where the medium contact portion in the guide portion is curved or bent.

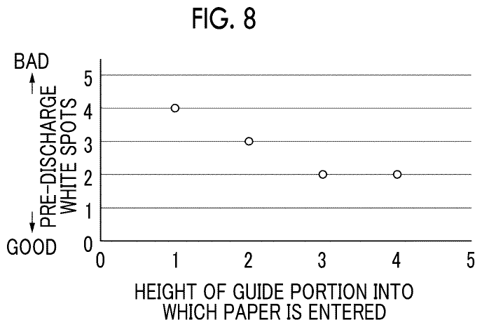

FIG. 8 is a graph showing a relationship between the height of the guide portion 202 in a case where the paper P is entered the secondary transfer position NT and the occurrence status of the white spots due to the pre-discharge immediately before the secondary transfer position NT. A horizontal axis of the graph shown in FIG. 8 indicates the height of the guide portion 202 which is increased from the reference height “0” of the guide portion 202. In addition, a vertical axis of the graph shown in FIG. 8 shows the occurrence status of the white spots due to the pre-discharging in numerical values in a stepwise manner, and shows that the occurrence status of the white spots deteriorates as the numerical value increases. In addition, the incidence angle of the intermediate transfer belt 31 with respect to the horizontal direction at the secondary transfer position NT is 6 degrees, and the process speed is 1000 mm/s. In addition, a paper having a predetermined basis weight (500 gsm) is used as the paper P. As shown in FIG. 8, it can be seen that the occurrence status of the white spots due to the pre-discharges is improved by increasing the height of the guide portion 202 in the up-down direction. Therefore, it can be seen that the narrower the interval between the paper P and the intermediate transfer belt 31, the better the occurrence status of the white spots due to the pre-discharging.

### Fourth Exemplary Embodiment

Next, an image forming system according to a fourth exemplary embodiment will be described. The identical components to the configurations of the first to third exemplary embodiments described above will be denoted the identical reference numerals and the description thereof will be omitted.

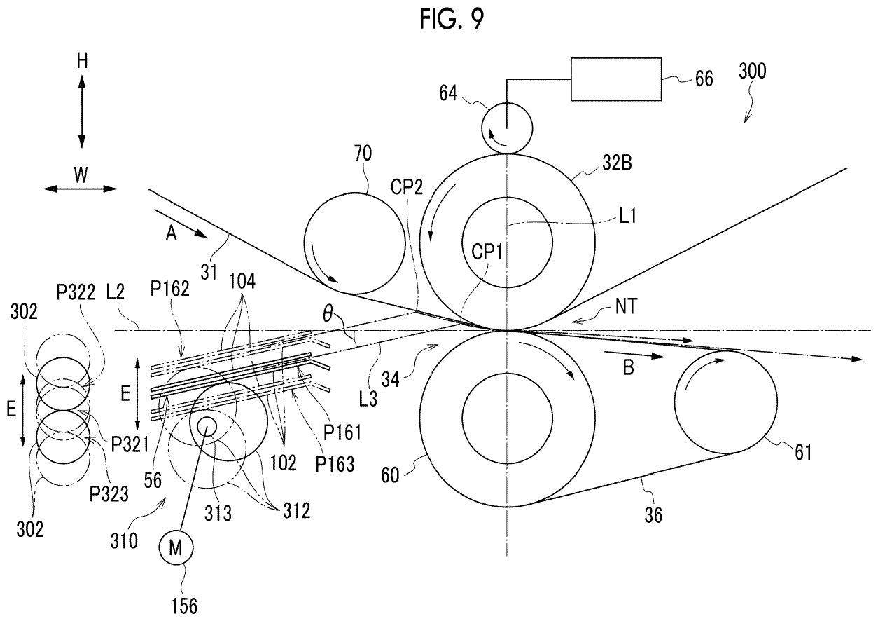

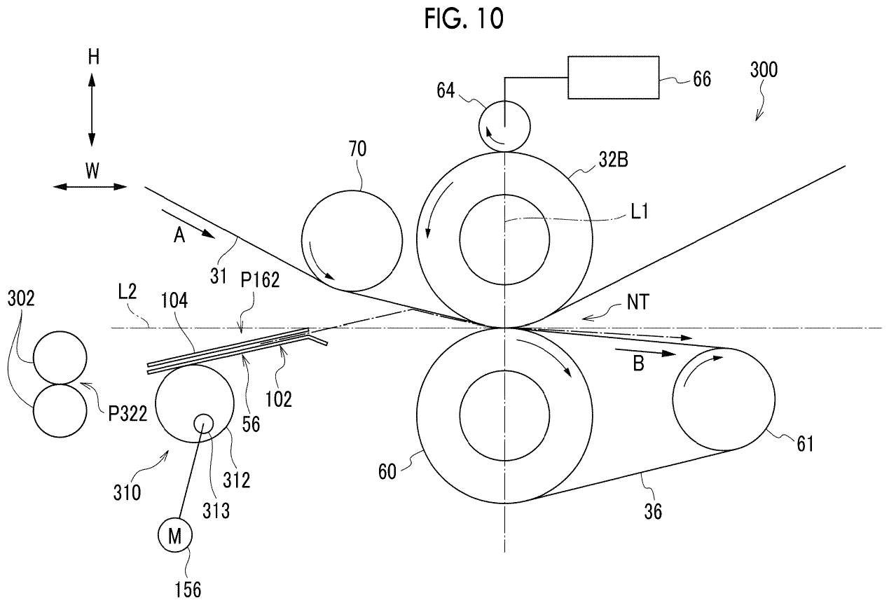

An image forming system 300 of the fourth exemplary embodiment is different from the image forming system 150 of the second exemplary embodiment (refer to FIG. 4) in that the position of a registration roll 302 is moved as shown in FIGS. 9 and 10, whereas the position of the registration roll 54 is fixed. The registration roll 302 is an example of an adjustment roll. The registration roll 302 is provided on the upstream side of the guide portion 56 in the transport direction of the paper P, and adjusts the transport timing of the paper P transported to the secondary transfer position NT. The registration roll 302 is configured by a pair of upper and lower rolls.

The image forming system 300 includes a movement portion 310 that integrally moves the guide portion 56 and the registration roll 302 in a direction approaching or separating from the intermediate transfer belt 31. Although not shown, the image forming system 300 is provided with a support frame that integrally supports the guide portion 56 and the registration roll 302. The registration roll 302 is rotatably supported by a support frame. The movement portion 310 includes a cam 312 that comes into contact with the support frame in the vicinity of the lower surface of the planar portion 102A of the plate-like portion 102, and a motor 156 that rotates a shaft portion 313 of the cam 312. As an example, the movement portion 310 integrally moves the guide portion 56 and the registration roll 302 in the up-down direction (the direction of the arrow E) by moving the support frame by the rotation of the cam 312. Accordingly, the movement portion 310 moves the registration roll 302 in a direction approaching or separating from the intermediate transfer belt 31 according to the movement position of the guide portion 56. As an example, the movement portion 310 moves the registration roll 302 in the up-down direction (the direction of the arrow E) by the same distance as the guide portion 56. The movement portion 310 is an example of a second movement portion that is configured to also serve as a movement portion that moves the guide portion 56.

Specifically, the movement portion 310 moves the guide portion 56 to a first position P161, a second position P162, and a third position P163 in the up-down direction (the direction of the arrow E) by the rotation of the cam 312. The first position P161 is a reference position in the middle in the up-down direction. The second position P162 is a position on the upper side (+H direction) of the first position P161 and is a position close to the intermediate transfer belt 31. The third position P163 is a position on the lower side (−H direction) of the first position P161 and is a position far from the intermediate transfer belt 31.

In this case, the movement portion 310 moves the registration roll 302 to a first position P321, a second position P322, and a third position P323 in the up-down direction (the direction of the arrow E) in accordance with the movement position of the guide portion 56. The first position P321 is a reference position in the middle of the up-down direction. The second position P322 is a position on the upper side (+H direction) of the first position P321 and is a position close to the intermediate transfer belt 31. The third position P323 is a position that is on the lower side (−H direction) of the first position P321 and is a position far from the intermediate transfer belt 31. In addition, other configurations of the image forming system 300 are the same as the image forming system 150 according to the second exemplary embodiment.

In the image forming system 300 of the fourth exemplary embodiment, in addition to the actions and effects of the same configuration as the image forming system 10 of the first exemplary embodiment, the following actions and effects can be obtained.

The image forming system 300 includes a registration roll 302 and a movement portion 310 that moves the registration roll 302 in a direction approaching to or separating from the intermediate transfer belt 31 according to a movement position of the guide portion 56. Accordingly, in a case where the paper P transported by the registration roll 302 is guided to the secondary transfer position NT by the guide portion 56, the paper P is less likely to be curved, and the bending or the like of the paper P is less likely to occur. Therefore, in the image forming system 300, the occurrence of damage on the paper P is suppressed as compared with a case where the position of the adjustment roll is fixed when the guide portion is moved.

### Supplementary Description

In the image forming systems 10, 150, 200, and 300 of the first to fourth exemplary embodiments, the guide portions 56 and 202 are configured by the pair of plate-like portions 102 and 104, the plate-like portion 104 has a planar shape, and the main part of the plate-like portion 102 has a planar shape. However, the present disclosure is not limited to this configuration. For example, the guide portion may be configured by a plate-like portion bent at an intermediate portion in a paper transport direction. In addition, for example, the guide portion may not be a pair of plate-like portions and may be configured by one plate-like portion.

In addition, in the image forming systems 10, 150, 200, and 300 of the first to fourth exemplary embodiments, the secondary transfer voltage is applied to the inner roll 32B, but the present disclosure is not limited to this configuration. For example, a configuration may be provided in which the secondary transfer voltage is applied to the secondary transfer roll 60.

In addition, in the image forming system 300 of the fourth exemplary embodiment, the movement portion 310 integrally moves the guide portion 56 and the registration roll 302, but the present disclosure is not limited to the configuration. For example, the movement portion that moves the guide portion 56 and the second movement portion that moves the registration roll 302 may be provided separately.

In the image forming systems 10, 150, 200, and 300 according to the first to fourth exemplary embodiments, the paper P is transported along the horizontal direction at the secondary transfer position NT, and the toner image of the intermediate transfer belt 31 is transferred to the paper P. However, the present disclosure is not limited to this configuration. For example, in the image forming system, a configuration may be provided in which the paper P is transported along the up-down direction at the secondary transfer position NT, and the toner image of the intermediate transfer belt 31 is transferred to the paper P. In this case, a configuration may be provided in which a movement portion that moves the entire medium contact portion in the guide portion in a direction approaching or separating from the intermediate transfer belt according to the type of the paper P while maintaining a posture in a direction intersecting a line connecting the center of the transfer rotating body and the center of the counter rotating body is provided.

In the image forming systems 10, 150, 200, and 300 of the first to fourth exemplary embodiments, the paper P is used, but a medium such as a film may be used instead of the paper P.

Note that, although a specific exemplary embodiment of the present invention has been described in detail, the present invention is not limited to the exemplary embodiment and it is obvious to persons skilled in the art that other various exemplary embodiments are possible without departing from the scope of the present invention.

### Supplementary Note

(((1)))

An image forming system comprising:
an endless intermediate transfer body that is wound around a plurality of rolls and moves in a circulation direction, and transports a toner image that is primarily transferred onto an outer peripheral surface;
a transfer rotating body that rotates and comes into contact with the intermediate transfer body, and transfers the toner image of the intermediate transfer body onto a medium at a secondary transfer position facing the intermediate transfer body;
a counter rotating body that rotates and faces the transfer rotating body while interposing the intermediate transfer body, and forms a potential difference between the transfer rotating body and the counter rotating body;
a guide portion that is provided on an upstream side of the secondary transfer position in a transport direction of the medium, and guides the medium to the secondary transfer position; and
a movement portion that moves an entire medium contact portion in the guide portion in a direction approaching or separating from the intermediate transfer body while maintaining a posture in a direction intersecting a line connecting a center of the transfer rotating body and a center of the counter rotating body, according to a type of the medium.
   (((2)))

The image forming system according to (((1))),
wherein the movement portion moves the entire medium contact portion in the guide portion in the direction approaching the intermediate transfer body in a case where the medium is a medium having a thickness larger than a predetermined thickness or a film medium, as compared with a case of the medium having the predetermined thickness.
   (((3)))

The image forming system according to (((1))) or (((2))),
wherein the movement portion moves the entire medium contact portion in the guide portion in the direction separating from the intermediate transfer body in a case where the medium is a medium having a surface smoother than a predetermined smoothness, as compared with a case of the medium having the predetermined smoothness.
   (((4)))

The image forming system according to any one of (((1))) to (((3))),
wherein the movement portion moves the entire medium contact portion in the guide portion in the direction approaching or separating from the intermediate transfer body in accordance with a secondary transfer voltage applied to the transfer rotating body or the counter rotating body.
   (((5)))

The image forming system according to (((4))),
wherein the movement portion moves the entire medium contact portion in the guide portion in the direction approaching the intermediate transfer body in a case where the secondary transfer voltage is higher than a reference voltage, as compared with a case where the secondary transfer voltage is equal to or lower than the reference voltage.
   (((6)))

The image forming system according to any one of (((1))) to (((5))), further comprising:
a rotating member that comes into contact with an inside of the intermediate transfer body on a downstream side of the intermediate transfer body in a circulation direction from a primary transfer position at which the toner image is transferred to the intermediate transfer body and an upstream side of the intermediate transfer body in the circulation direction from the counter rotating body,
wherein a contact point at which the medium guided by the guide portion comes into contact with the intermediate transfer body is on the downstream side of the intermediate transfer body in the circulation direction from the rotating member.
   (((7)))

The image forming system according to any one of (((1))) to (((6))),
wherein the transport direction of the medium guided by the guide portion is a direction along a virtual tangent line of the transfer rotating body that is orthogonal to the line connecting the center of the transfer rotating body and the center of the counter rotating body.
   (((8)))

The image forming system according to (((7))),
wherein the medium contact portion in the guide portion has a planar shape in a side view.
   (((9)))

The image forming system according to any one of (((1))) to (((8))),
wherein, in a case where the guide portion is moved in the direction approaching the intermediate transfer body and in a case where the guide portion is moved in the direction separating from the intermediate transfer body by the movement portion, movement is performed such that an angle between a virtual tangent line of the transfer rotating body that is orthogonal to the line connecting the center of the transfer rotating body and the center of the counter rotating body and the medium contact portion in the guide portion falls in a range of ±4 degrees from an angle before movement.
   (((10)))

The image forming system according to any one of (((1))) to (((9))), further comprising:
an adjustment roll that is provided on an upstream side of the guide portion in the transport direction of the medium and adjusts a transport timing of the medium; and
a second movement portion that moves the adjustment roll in the direction approaching or separating from the intermediate transfer body in accordance with a movement position of the guide portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an endless intermediate transfer body that is wound around a plurality of rolls and moves in a circulation direction, and transports a toner image that is primarily transferred onto an outer peripheral surface;
a transfer rotating body that rotates and comes into contact with the intermediate transfer body, and transfers the toner image of the intermediate transfer body onto a medium at a secondary transfer position facing the intermediate transfer body;
a counter rotating body that rotates and faces the transfer rotating body while interposing the intermediate transfer body, and forms a potential difference between the transfer rotating body and the counter rotating body;
a guide portion that is provided on an upstream side of the secondary transfer position in a transport direction of the medium, and guides the medium to the secondary transfer position; and
a movement portion that moves an entire medium contact portion in the guide portion in a direction approaching or separating from the intermediate transfer body while maintaining a posture in a direction intersecting a line connecting a center of the transfer rotating body and a center of the counter rotating body, according to a type of the medium.

2. The image forming system according to claim 1,
wherein the movement portion moves the entire medium contact portion in the guide portion in the direction approaching the intermediate transfer body in a case where the medium is a medium having a thickness larger than a predetermined thickness or a film medium, as compared with a case of the medium having the predetermined thickness.

3. The image forming system according to claim 1,
wherein the movement portion moves the entire medium contact portion in the guide portion in the direction separating from the intermediate transfer body in a case where the medium is a medium having a surface smoother than a predetermined smoothness, as compared with a case of the medium having the predetermined smoothness.

4. The image forming system according to claim 1,
wherein the movement portion moves the entire medium contact portion in the guide portion in the direction approaching or separating from the intermediate transfer body in accordance with a secondary transfer voltage applied to the transfer rotating body or the counter rotating body.

5. The image forming system according to claim 4,
wherein the movement portion moves the entire medium contact portion in the guide portion in the direction approaching the intermediate transfer body in a case where the secondary transfer voltage is higher than a reference voltage, as compared with a case where the secondary transfer voltage is equal to or lower than the reference voltage.

6. The image forming system according to claim 1, further comprising:
a rotating member that comes into contact with an inside of the intermediate transfer body on a downstream side of the intermediate transfer body in a circulation direction from a primary transfer position at which the toner image is transferred to the intermediate transfer body and an upstream side of the intermediate transfer body in the circulation direction from the counter rotating body,
wherein a contact point at which the medium guided by the guide portion comes into contact with the intermediate transfer body is on the downstream side of the intermediate transfer body in the circulation direction from the rotating member.

7. The image forming system according to claim 1,
wherein the transport direction of the medium guided by the guide portion is a direction along a virtual tangent line of the transfer rotating body that is orthogonal to the line connecting the center of the transfer rotating body and the center of the counter rotating body.

8. The image forming system according to claim 7,
wherein the medium contact portion in the guide portion has a planar shape in a side view.

9. The image forming system according to claim 1,
wherein, in a case where the guide portion is moved in the direction approaching the intermediate transfer body and in a case where the guide portion is moved in the direction separating from the intermediate transfer body by the movement portion, movement is performed such that an angle between a virtual tangent line of the transfer rotating body that is orthogonal to the line connecting the center of the transfer rotating body and the center of the counter rotating body and the medium contact portion in the guide portion falls in a range of ±4 degrees from an angle before movement.

10. The image forming system according to claim 1, further comprising:
an adjustment roll that is provided on an upstream side of the guide portion in the transport direction of the medium and adjusts a transport timing of the medium; and
a second movement portion that moves the adjustment roll in the direction approaching or separating from the intermediate transfer body in accordance with a movement position of the guide portion.
